(19) United States
(12) Patent Application Publication
(10) Pub. No.: US 2016/0091775 A1
(43) Pub. Date: Mar. 31, 2016

(54) GRATING-BASED LIGHT MODULATION EMPLOYING A LIQUID CRYSTAL

(71) Applicant: HEWLETT-PACKARD DEVELOPMENT COMPANY, L.P., Houston, TX (US)

(72) Inventors: Gary Gibson, Palo Alto, CA (US); David A. Fattal, Mountain View, CA (US)

(21) Appl. No.: 14/892,556

(22) PCT Filed: Jun. 20, 2013
(86) PCT No.: PCT/US2013/046873

§ 371 Date: Nov. 19, 2015

(51) Int. Cl. G02F 1/313; G02B 27/22; F21V 8/00

(52) U.S. Cl. CPC G02F 1/313; G02B 6/0035; G02B 27/22

(57) ABSTRACT

A light modulator includes a light guide to guide light by total internal reflection, a diffraction grating at a surface of the light guide, and a liquid crystal in contact with the diffraction grating. The liquid crystal has a first state with a first refractive index that substantially matches a refractive index of a material of the diffraction grating to defeat the diffractive coupling. The liquid crystal has a second state with a second refractive index that differs from the first refractive index to facilitate the diffractive coupling.

### CROSS-REFERENCE TO RELATED APPLICATIONS

N/A

### STATEMENT REGARDING FEDERALLY SPONSORED RESEARCH OR DEVELOPMENT

N/A

### BACKGROUND

Light modulators or more generally electro-optic modulators are employed in a variety of applications ranging from optical communications to electronic displays. For example, light modulators may be employed to modulate light emitted by a backlight in many modern electronic displays. The light modulators may modulate the emitted light in discrete spatially separated regions of the electronic display representing pixels. Light emitted by the backlight is directed through and modulated by the light modulator to vary an intensity of the light emitted by the pixel, for example. Light modulators used in optical communications may employ any of a variety of means including, but not limited to, amplitude modulation, phase modulation and polarization modulation to encode information for transmission on an optical beam within an optical transmission line (e.g., a fiber optic cable).

As suggested above, light modulators may be used to vary or modulate one or more of amplitude or intensity, phase and polarization of a light beam, for example. Light modulators that modulate light using amplitude modulation (i.e., optical amplitude modulators) are sometimes referred to as light valves. Amplitude modulation in a light valve may be accomplished through a change in transmission (e.g., a transmissive light valve) or a change in reflection (e.g., a reflective light valve), for example. The change in transmission may result from a change in an absorption characteristic of the light valve, for example. A liquid crystal light valve typically provides amplitude modulation through a change in a transmission characteristic accomplished using a polarization shift of light passing through the liquid crystal light valve, for example. Reflection light valves may employ a change in direction of a light beam provided by a micromechanical mirror, for example, to affect amplitude modulation of the light beam. In addition, amplitude modulation may be accomplished using phase changes in the optical beam such as in an interferometric light valve, for example.

### BRIEF DESCRIPTION OF THE DRAWINGS

Various features of examples in accordance with the principles described herein may be more readily understood with reference to the following detailed description taken in conjunction with the accompanying drawings, where like reference numerals designate like structural elements, and in which:

FIG. 1 illustrates a cross sectional view of a grating-based light modulator, according to an example consistent with the principles described herein.

FIG. 2 illustrates a cross sectional view of a grating-based light modulator, according to another example consistent with the principles described herein.

FIG. 3A illustrates a cross sectional view of a portion of a grating-based light modulator, according to an example consistent with the principles described herein.

FIG. 3B illustrates a cross sectional view of the portion of the grating-based light modulator of FIG. 3A, according to an example consistent with the principles described herein.

FIG. 4A illustrates a cross sectional view of a portion of another grating-based light modulator, according to an example consistent with the principles described herein.

FIG. 4B illustrates a cross sectional view of the portion of the grating-based light modulator of FIG. 4A, according to an example consistent with the principles described herein.

FIG. 5 illustrates block diagram of an electronic display, according to an example consistent with the principles described herein.

FIG. 6 illustrates a flow chart of a method of grating-based light modulation, according to an example consistent with the principles described herein.

Certain examples have other features that are one of in addition to and in lieu of the features illustrated in the above-referenced figures. These and other features are detailed below with reference to the above-referenced figures.

### DETAILED DESCRIPTION

Examples in accordance with the principles described herein provide light modulation using liquid crystal based diffractive coupling modulation. In particular, light modulation described herein employs a refractive index of a liquid crystal to change or modify a diffractive coupling. The change in the diffractive coupling, in turn, changes an amount of light coupled out of a light guide resulting in a modulation of the coupled-out light. Unlike polarization-based liquid crystal based light modulation, light modulation according to the principles described herein does not employ a pair of crossed polarizers, such that compact, efficient light modulator implementations are facilitated that generally use fewer layers and components. Among applications of the light modulation using liquid crystal based diffractive coupling modulation described herein is a modulated backlight for an electronic display, for example. In another example, the light modulation described herein may provide a modulated light field (e.g., an array of modulated beams or beamlets) for a display such as, but not limited to, an autostereoscopic three-dimensional (3-D) display (e.g., a so-called ‘glasses-free’ 3-D display).

According to various examples of the principles described herein, a diffraction grating is employed to couple light our of a light guide by diffractive coupling. Changes in a refractive index of a liquid crystal in contact with the diffraction grating are used to alternately facilitate and defeat the diffractive coupling to modulate the coupled out light. The light guide may be a light guide of a backlight of an electronic display, for example. The diffraction grating includes or is made up of features (grooves, ridges, holes, bumps, etc.) formed in a surface of the light guide. The liquid crystal is in contact with the diffraction grating to fill in and around the features of the diffraction grating. When the liquid crystal has a refractive index that matches a refractive index of the diffraction grating, a refractive index distinction between the features and a surrounding environment is substantially mitigated. As such, the diffraction grating no longer diffracts light and thus diffractive coupling of light from the light guide ceases or is defeated (i.e., based on extent to which a refractive index match is achieved). Alternatively, when the liquid crystal exhibits a refractive index that differs from the diffraction grating refractive index, the diffraction grating operates normally to provide diffractive coupling to couple out the light. The liquid crystal may be switched between a matched refractive index and a mismatched refractive index with respect to a substantially constant diffraction grating refractive index. Such switching may be provided by changing a state of the liquid crystal (e.g., an orientation of molecules within the liquid crystal). The state change may be provided by an applied electric field, according to some examples.

Herein, as ‘diffraction grating’ is defined as a plurality of features arranged to provide diffraction of light incident on the features. Further by definition herein, the features of a diffraction grating are features formed one or more of at, in and on a surface of a material or structure that supports propagation of light. For example, the material may be a material of a light guide and the structure may be the light guide. The features may include any of a variety of features or structures that diffract light including, but not limited to, grooves, ridges, holes and bumps on the material surface. For example, the diffraction grating may include a plurality of parallel grooves in the material surface. In another example, the diffraction grating may include a plurality of parallel ridges rising out of the material surface. A diffraction angle θₘ of light diffracted by a periodic diffraction grating may be given by equation (1) as:

$${θ}_{m} = {sin}^{- 1} ( \frac{m λ}{d} - n \cdot sin {θ}_{i} ) \qquad ( 1 )$$

where λ is a wavelength of the light, m is a diffraction order, d is a distance between features of the diffraction grating, n is a refractive index of the light guide material, and θᵢ is an angle of incidence of the light on the diffraction grating. According to various examples, a material of the diffraction grating is substantially transparent (e.g., at an operational wavelength of the diffraction grating).

The plurality of features of the diffraction grating may be arranged in a periodic array. In some examples, the diffraction grating may include a plurality of features arranged in a one-dimensional (1-D) array. For example, a plurality of parallel grooves is a 1-D array. In other examples, the diffraction grating may include a two-dimensional (2D) array of features. For example, the diffraction grating is a 2-D array of bumps on a material surface. The features (e.g., grooves, ridges, holes, bumps, etc.) may have any of a variety of cross sectional shapes or profiles that provide diffraction including, but not limited to, one or more of a rectangular profile, a triangular profile and a saw tooth profile.

Herein, ‘diffractive coupling’ is defined as coupling of an electromagnetic wave (e.g., light) across a boundary between two materials as a result of diffraction (e.g., by a diffraction grating). For example, a diffraction grating may be used to couple out light propagating in a light guide by diffractive coupling across a boundary of the light guide. The diffractive coupling substantially overcomes total internal reflection that guides the light within the light guide to couple out the light, for example.

Further herein, a ‘light guide’ is defined as a structure that guides light within the structure using total internal reflection. In particular, the light guide may include a core that is substantially transparent at an operational wavelength of the light guide. In some examples, the term ‘light guide’ generally refers to a dielectric optical waveguide that provides total internal reflection to guide light at an interface between a dielectric material of the light guide and a material or medium that surrounds that light guide. For example, a refractive index of the light guide material may be greater than a refractive index of the surrounding medium to provide total internal reflection of the guided light. In some examples, the light guide may include a coating in addition to or instead of the aforementioned refractive index difference to provide the total internal reflection. The coating may be a reflective coating, for example.

Further herein, the term ‘plate’ when applied to a light guide as in a ‘plate light guide’ is defined to mean piecewise or differentially planar. In particular, a plate light guide is defined as a light guide configured to guide light in two substantially orthogonal directions bounded by a top surface and a bottom surface of the light guide. Further, by definition herein, the top and bottom surfaces are both separated from one another and substantially parallel to one another in a differential sense. As such, within any differentially small region of the plate light guide, the top and bottom surfaces are substantially parallel or co-planar. In some examples, a plate light guide may be substantially flat (e.g., confined to a plane) and so the plate light guide is a planar light guide. In other examples, the plate light guide may be curved in one or two orthogonal dimensions. For example, the plate light guide may be curved in a single dimension to form a cylindrical shaped plate light guide. In various examples however, any curvature has a radius of curvature sufficiently large to insure that total internal reflection is maintained within the plate light guide to guide light.

A ‘liquid crystal’ or a ‘liquid crystal material’ is defined herein as a fluid or liquid material that has properties of a crystal. In particular, a liquid crystal may exhibit one or more of a nematic phase, a Smectic phase, a chiral phase or discotic phase, according to various examples herein. Further, liquid crystals or liquid crystal materials may exhibit birefringence. Birefringence is a property of a material according to which light with different polarizations may experience different refractive indices as the light passes through or interacts with the material. For example, a birefringent crystal material such as a birefringent liquid crystal exhibits both a so-called ‘ordinary’ refractive index (nₒ) and an ‘extraordinary’ refractive index (nₑ) depending on a particular polarization of the light. In liquid crystals, selection between the ordinary refractive index nₒ and the extraordinary refractive index nₑ may be provided by selecting a state of the liquid crystal. In particular, depending on an orientation of molecules of the liquid crystal, light having a particular polarization may experience a different refractive index (e.g., nₒ vs. nₑ) depending on the state of the liquid crystal. Further, the state of the liquid crystal and by extension the refractive index thereof may be switched or changed (e.g., by application of heat, electric field, etc.) to selectively change the refractive index, according to various examples.

Herein, a ‘state’ of a liquid crystal is defined as a predetermined orientation of molecules of the liquid crystal. For example, rod-like molecules in a nematic phase liquid crystal (i.e., a nematic liquid crystal) may be characterized by a so-called ‘director’ that points in a direction parallel with a long axis of the rod-like molecules. The state of the nematic liquid crystal may be switched (e.g., by applying an electric field) between an alignment of the director that is substantially parallel to a substrate and an alignment of the director that is substantially perpendicular to the substrate. The substantially parallel alignment is referred to as a ‘homogeneous alignment’ and the substantially perpendicular alignment is referred to as a ‘homeotropic alignment’, by definition herein. Light having a transverse electric (TE) polarization relative to a plane of the substrate will experience different refractive indices depending on whether the liquid crystal is set to a state corresponding to the homogeneous alignment or another state corresponding o the homeotropic alignment, for example. As such, the state of the liquid crystal may be used to selectively control the refractive index experienced by the light passing through or interacting with a liquid crystal.

Further still, as used herein, the article ‘a’ is intended to have its ordinary meaning in the patent arts, namely ‘one or more’. For example, ‘a grating’ means one or more gratings and as such, ‘the grating’ means ‘the grating(s)’ herein. Also, any reference herein to ‘top’, ‘bottom’, ‘upper’, ‘lower’, ‘up’, ‘down’, ‘front’, back’, ‘left’ or ‘right’ is not intended to be a limitation herein. Herein, the term ‘about’ when applied to a value generally means within the tolerance range of the equipment used to produce the value, or in some examples, means plus or minus 10%, or plus or minus 5%, or plus or minus 1%, unless otherwise expressly specified. Further, herein the term ‘substantially’ as used herein means a majority, or almost all, or all, or an arnount with a range of about 51% to about 100%, for example. Moreover, examples herein are intended to be illustrative only and are presented for discussion purposes and not by way of limitation.

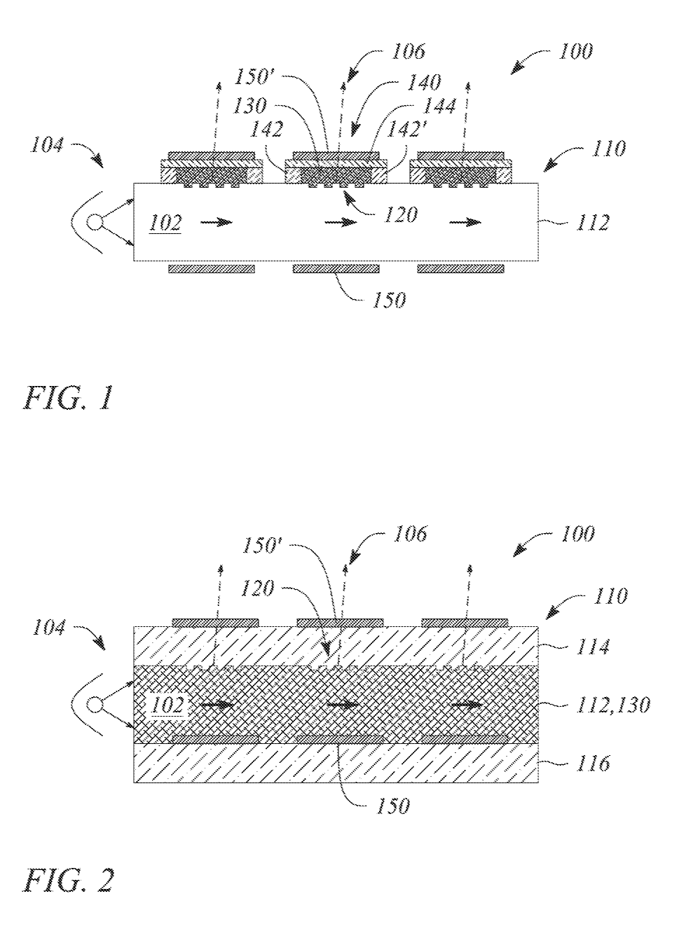

According to some examples of the principles described herein, a grating-based light modulator is provided. FIG. 1 illustrates a cross sectional view of a grating-based light modulator 100, according to an example consistent with the principles described herein. FIG. 2 illustrates a cross sectional view of a grating-based light modulator 100, according to another example consistent with the principles described herein. The grating-based light modulator 100 is configured to couple out and modulate a portion of light 102 that propagates within the grating-based light modulator 100. Both the coupling out and the modulation are provided using liquid crystal (LC) modulated diffractive coupling, according to various examples.

In particular, the light 102 from a light source 104 propagates in the grating-based light modulator 100. A general propagation direction of the light 102 within the grating-based light modulator 100 (i.e., before being coupled out) is illustrated by a heavy arrow in FIGS. 1 and 2. The grating-based light modulator 100 emits the coupled out and modulated portion of the light 102 as modulated light 106. The modulated light 106 may be emitted as a beam of light. In various examples, the beam of modulated light 106 may have both a predetermined direction and a relatively narrow angular spread. The modulated light 106 is configured to propagate in a direction away from the grating-based light modulator 100 that is substantially different from a propagation direction of the light 102 within the grating-based light modulator 100. As a light beam, the modulated light 106 may propagate in a direction that is substantially perpendicular to a general propagation direction of the light 102 propagating within the grating-based light modulator 100.

The modulated light 106 (e.g., a modulated light beam) has an intensity or brightness determined by or that is a function of a state of a liquid crystal used to modulate the diffractive coupling. In some examples, the LC modulated diffractive coupling is configured to switch or change the intensity of the modulated light 106 between two states. A first or ‘ON’ state of the two states may be a full or maximum intensity of the modulated light 106, while a second or ‘OFF’ state may represent a minimum intensity (i.e., substantially no light) of the modulated light 106 that is produced by the grating-based light modulator 100. In other examples, the LC modulated diffractive coupling may produce modulated light 106 having a plurality of intensity values or states. The plurality of intensity states may range between the ON state and the OFF state.

In various examples, the light source 104 may be substantially any source of light including, but not limited to, one or more of is light emitting diode (LED), a fluorescent light and a laser. In some examples, the light source 104 may produce a substantially monochromatic light 102 having a narrowband spectrum denoted by a particular color. In particular, the color of the monochromatic light 102 may be a primary color of a particular color gamut or color model (e.g., a red-green-blue (RGB) color model). The light source 104 may be a red LED and the monochromatic light 102 is substantially the color red. The light source 104 may be a green LED and the monochromatic light 102 is substantially green in color. The light source 104 may be a blue LED and the monochromatic light 102 is substantially blue in color. In other examples, the light 102 provided by the light source 104 has a substantially broadband spectrum. For example, the light 102 produced by the light source 104 may be white light. The light source 104 may be a fluorescent light that produces white light.

As illustrated in FIGS. 1 and 2, the grating-based light modulator 100 includes a plate light guide 110. The plate light guide 110 is configured to guide the light 102 from the light source 104. In particular, the plate light guide 110 guides the light 102 using total internal reflection. The plate light guide 110 may include a dielectric material configured as an optical waveguide. The dielectric material may have a refractive index that is greater than a refractive index of a medium surrounding the dielectric optical waveguide. The difference between the refractive indices of the dielectric material and the surrounding medium is configured to facilitate total internal reflection of the light 102 guided according to one or more guided modes in the plate light guide 110. In some examples, the guided light 102 may be coupled into an end of the plate light guide 110 and propagate along a length thereof. A lens (not illustrated) may facilitate coupling of light into the plate light guide 110 at the end thereof for example.

In some examples (e.g., as illustrated in cross section in FIG. 1), the plate light guide 110 is a slab or plate optical waveguide that includes guide layer 112. The guide layer 112 is configured to guide the light 102 by total internal reflection within the guide layer 112 and may be a sheet of optically transmissive material that is substantially solid according to some examples. In particular, the substantially solid optically transmissive material of the guide layer 112 has a refractive index that is higher than a refractive index external to the sheet to facilitate guiding of the guided light 112 by total internal reflection. As used herein, an ‘optically transmissive’ material is defined as a material having an optical absorption that sufficiently low at a predefined operational wavelength to enable use of the material as a light guide. For example, the optically transmissive material may be optically transparent or substantially optically transparent at the operational wavelength of the guide layer 112.

In some examples, the plate light guide 110 may include a cladding layer on a surface of the guide layer 112 of the plate light guide 110 (not illustrated). The cladding layer may be used to further facilitate total internal reflection. In some examples, the sheet of optically transmissive material of the guide layer 112 is an extended, substantially planar sheet of dielectric material. According to various examples, the optically transmissive material may include or be made up of an of a variety of dielectric materials including, but not limited to, various types of glass (e.g., silica glass, alkali-aluminosilicate glass, borosilicate glass, etc.) and optically transparent plastics or polymers (e.g., poly(methyl methacrylate) or acrylic glass, polycarbonate, etc.).

In other examples (e.g., as illustrated in FIG. 2), the plate light guide 110 further includes a top plate 114 and a bottom plate 116 with the guide layer 112 sandwiched between the top and bottom plates 114, 116. In these examples, the guide layer 112 has a refractive index that is higher than a refractive index of both of the top plate 114 and the bottom plate 115 to guide the guided light 102 within the guide layer 112 by total internal reflection. In some of these examples, the sandwiched guide layer 112 is a liquid or a quasi-liquid. In particular, the sandwiched guide layer 112 may be a liquid crystal (LC) or include a liquid crystal material, in some examples (as further described below). According to various examples, the top and bottom plates 114, 116 comprise a substantially planar sheet of a dielectric material such as, but not limited to, various types of glass (e.g., silica glass, alkali-aluminosilicate glass, borosilicate glass, etc.) and optically transparent plastics (e.g., poly(methyl methacrylate) or acrylic glass, polycarbonate, etc.).

As illustrated by the heavy arrows in FIGS. 1 and 2, the guided light 102 from the light source 104 may propagate along the plate light guide 110 in a generally horizontal direction. Propagation of the guided light 102 in the generally horizontal propagation direction may be according to one or more optical beams that represent plane waves of propagating light associated with one or more of the optical modes of the plate light guide 110, for example. The optical beams of the guided light 102 bounce or reflect off ‘walls’ of the guide layer 112 of the plate light guide 110 at an interface between the material (e.g., dielectric) of the guide layer 112 and a surrounding medium (e.g., air as in FIG. 1 or top and bottom plates 114, 116 as illustrated in FIG. 2) due to the difference in refractive indices between the material of the guide layer 112 and the surrounding medium. The reflection occurs when the optical beams encounter the interface at less than a critical angle for the interface. The reflection provides the total internal reflection responsible for guiding the guided light 102.

The grating-based light modulator 100 illustrated in FIGS. 1 and 2 further includes a diffraction grating 120 at a surface of the plate light guide 110. In particular, the diffraction grating 120 is at a surface of the guide layer 112 of the plate light guide 110, according to various examples. The diffraction grating 120 is configured to couple out a portion of the guided light 102 through the surface of the guide layer 112 by or using diffractive coupling. According to various examples, diffractive coupling couples out a portion of the guided light 102 in a direction that is different from a direction of propagation of the guided light 102 in the plate light guide 110. The coupled out portion of the guided light 102 may be directed away from the surface of the guide layer 112 at a diffraction angle relative to the surface. The diffraction angle may be between 60 and 120 degrees, for example. As illustrated in FIGS. 1 and 2, the diffraction angle is about 90 degrees. As illustrated, the coupled out portion of the guided light 102 is the modulated light 106 emitted from the grating-based light modulator 100. A dashed line arrow is used in FIGS. 1 and 2 to illustrate the modulated light 106 to further emphasize modulation thereof.

As provided above, the diffraction grating 120 is located at the surface of the guide layer 112 of the plate light guide 110. The diffraction grating 120 may include a plurality of grooves or ridges that either penetrate into or extend from, respectively, the surface of the guide layer 112. The grooves may be milled or molded into a material at the surface. As such, a material of the diffraction grating 120 may include a material of the guide layer 112. For example, FIG. 1 illustrates the diffraction grating 120 as a plurality of parallel grooves that penetrate a top surface of a dielectric material of the guide layer 112. In another example, the diffraction grating 120 may be formed in a surface of the top plate 114 adjacent to the guide layer 112. For example, the diffraction grating 120 may include parallel ridges or bumps that extend from a bottom surface of the top plate 114 on n side of the top plate 114 adjacent to the guide layer 112, as illustrated in FIG. 2. As such, the diffraction grating material may include a material of the top plate 114.

In yet other examples (not illustrated), the diffraction grating 120 may be a film or layer applied or affixed to a surface of the plate light guide 110. For example, the film or layer that provides the diffraction grating 120 may be applied to the top surface of the guide layer 112 when the guide layer 112 is made of a solid material e.g. as in the configuration of FIG. 1. In another example, the film or layer that provides the diffraction grating 120 may be applied to the bottom surface of the top plate 114 adjacent to the guide layer 112 when the guide layer is a liquid material, e.g. as in the FIG. 2 configuration. In these examples, the refractive index of the diffraction grating 120 may be determined by the film or layer instead of by a refractive index of a material that supports the film or layer. For example, in the configuration of FIG. 2, a refractive index of the film or layer that provides the diffraction grating 120 may determine the diffraction grating refractive index instead of the index of refraction of the top plate 114 itself.

In some examples, the diffraction grating 120 may include both the material of either the guide layer 112 or the top plate 114 and a layer or film applied thereon (e.g., a thin film of material applied over grooves formed in the guide layer material or top plate material). In some examples, the grooves or ridges are substantially perpendicular to a propagation direction of the guided light 102 in the plate light guide 110. In other examples, the grooves or ridges may be oriented on the surface of the light guide at a slant to the propagation direction (e.g., an angle other than perpendicular).

The grating-based light modulator 100 further includes a liquid crystal 130 in contact with the diffraction grating 120. The liquid crystal 130 has a first state with a first refractive index that substantially matches a refractive index of a material of the diffraction grating 120 (‘diffraction grating refractive index’). The liquid crystal 130 has a second state with a second refractive index that differs from the first refractive index. The first refractive index that substantially matches the diffraction grating refractive index is configured to defeat the diffractive coupling of the guided light 102 through the surface of the plate light guide 110, according to various examples. The second refractive index is configured to facilitate the diffractive coupling. In particular, since the second refractive index differs from the first refractive index, the second refractive index similarly differs from the diffraction grating refractive index to facilitate the diffractive coupling. By ‘defeat the diffractive coupling’ herein it is meant that diffractive coupling is substantially prevented or mostly does not occur, as opposed to ‘facilitate the diffractive coupling’, which means herein that diffractive coupling can or does occur.

In some examples, the first refractive index may be the ordinary refractive index nₒ while the second refractive index may be the extraordinary refractive index nₑ. In other examples, the first refractive index may be the extraordinary refractive index nₑ and the second refractive index may be the ordinary refractive index nₒ. In yet other examples, one or both of the first and second refractive indices may be other than the extraordinary refractive index and the nₑ ordinary refractive index nₒ.

According to some examples, the diffraction grating refractive index and the first refractive index of the first state of the liquid crystal 130 are defined as being ‘matched’ when the respective refractive indices have values that are within about 10-20 percent of one another. In some examples, the refractive indices are considered matched when a difference therebetween is less than about 5 percent. In some examples, first refractive index of the first state of the liquid crystal 130 and the diffraction grating 120 are considered to be matched when they differ by less than about 1 percent. For example, a first refractive index of about 1.55 and a diffraction grating refractive index of about 1.5 would be considered matched, by definition herein. Likewise, the diffraction grating refractive index and second refractive index are ‘mismatched’ when the refractive index values differ from one another by more than about 10-20 percent, by definition herein. For example, a second refractive index of about 1.7 and a diffractive grating refractive index of about 1.5 are mismatched. In some examples, the respective refractive indices may be considered to be Mismatched when there is a difference of greater than about 5 percent between respective ones of the refractive indices.

In various examples, the liquid crystal 130 in contact with the diffraction grating 120 substantially fills features of the diffraction grating 120 to defeat diffractive coupling when a match between the first refractive index of the liquid crystal 130 and the diffraction grating is achieved. In particular, when the features are filled with the index-matched liquid crystal 130 (i.e., in the first state), the diffraction grating 120 no longer acts as a diffraction grating to diffract light. Instead, the filled diffraction grating 120 may appear to the guided light 102 as a substantially smooth, continuous surface of the plate light guide 110. Additionally, the liquid crystal 130 may be substantially transparent at an operational frequency of the grating-based light modulator 100.

In some examples, the liquid crystal 130 is substantially confined to a portion of the plate light guide surface that includes the diffraction grating 120. In particular, the confined liquid crystal 130 may be confined substantially outside of the plate light guide 110. As illustrated in FIG. 1, the liquid crystal 130 is confined substantially outside of the top surface of the guide layer 112 of the plate light guide 110 and in contact with the diffraction grating 120. The liquid crystal 130 may be confined by or within a housing or cavity on the surface of the guide layer 112, for example.

In particular, the grating-based light modulator 100 may further include a cavity 140 to confine the liquid crystal 130 outside of and adjacent to the surface of the guide layer 112. The cavity 140 may include a pair of walls 142, 142′ adjacent to and extending away from the guide layer surface. The cavity 140 further comprises a lid 144 to bridge between the walls 142, 142′ to confine the liquid crystal 130. As illustrated in FIG. 1, the walls 142, 142′ of the cavity 140 may be arranged on either side of the diffraction grating 120. Together the pair of walls 142, 142′ and the lid 144 are configured to confine the liquid crystal 130 in contact with the diffraction grating 120. The lid 144 may be made of an optically transmissive material (e.g., glass or plastic). In some examples, the walls 142, 142′ also may be made of an optically transmissive material.

In other examples (e.g., as illustrated in FIG. 2), the liquid crystal 130 is located within the plate light guide 110. In particular, the guide layer 112 may be or include the liquid crystal 130 (e.g., as mentioned above). In these examples the guided light 102 is guided by total internal reflection within the liquid crystal 130. The diffraction grating 120 may be at a top surface of the liquid crystal 130 guide layer 112. For example, the diffraction grating 120 may be at or formed in the bottom surface of the top plate 114 adjacent an interface between the top plate 114 and the liquid crystal 130 guide layer 112, as illustrated in FIG. 2.

The liquid crystal 130 may include substantially any liquid crystal material that has a first state and a second state with differing refractive indices, where a refractive index of one of the states substantially matches the diffraction grating refractive index to defeat the diffractive coupling. For example, the liquid crystal 130 may include one or more of a nematic liquid crystal (i.e., liquid crystal materials that exhibit a nematic phase, a chiral or a cholesteric nematic phase, etc.), a Smectic liquid crystal (e.g., liquid crystal materials that exhibit Smectic phase A or Smectic phase C), a discotic phase liquid crystal, and a various other birefringent liquid crystal materials.

In particular, the liquid crystal 130 may include a nematic liquid crystal in which the first state is characterized by a homeotropic alignment of molecules of the nematic liquid crystal and the second state is characterized by a homogeneous alignment of the nematic liquid crystal molecules. The homeotropic alignment may provide the first refractive index and the homogeneous alignment may provide the second refractive index. Alternatively, the homogeneous alignment may provide the first refractive index and the homeotropic alignment may provide the second refractive index.

For example, transverse electric (TE) polarized light may experience a relatively lower refractive index when passing through or interacting with the nematic liquid crystal 130 in the first state with the homeotropic alignment. The TE polarized light may experience a relatively higher refractive index when passing through the same nematic liquid crystal 130 in the second state with the homogeneous alignment. The relatively lower refractive index may substantially match the diffraction grating refractive index such that the diffractive coupling is defeated for the TE polarized light when the nematic liquid crystal in the first state and therefore, no modulated light 106 is emitted. The refractive index experienced by the TE polarized light with the nematic liquid crystal 130 in the second state may be sufficiently different from the refractive index of the diffraction grating material to facilitate diffractive coupling and therefore, emission of modulated light 106 from the grating-based light modulator 100.

In another example, light with a transverse magnetic (TM) polarization may experience a relatively higher refractive index when interacting with the nematic liquid crystal in the homeotropic alignment of the first state and a relatively lower refractive index when passing through the same nematic liquid crystal 130 having the homogeneous alignment characteristic of the second state. If the relatively higher refractive index (first state) is substantially matched to the diffraction grating refractive index, then diffractive coupling may be defeated with the nematic liquid crystal 130 in the first state for the TM polarized light. In this example, diffractive coupling may be facilitated when the nematic liquid crystal 130 is in the second state (homogeneous alignment). It should be clear that various other permutations of refractive index of the first and second states, light polarization and diffractive grating refractive index are possible. All such permutations are within the scope of the principles described herein.

Examples of liquid crystal materials that may be used as the liquid crystal 130 include, but are not limited to, 4′-Pentyl-4-biphenylcarbonitrile, 4-trans-pentylcyclohexylcyanobenzene MLC-9200-00, MLC-9200-100, MLC-6241-000, MLC-6608, TL-216, and E44. For example, 4′-Pentyl-4-biphenylcarbonitrile in a homeotropic alignment exhibits a refractive index of about 1.5 for TE polarized light and a refractive index of about 1.7 for TM polarized light. However, when in a homogeneous alignment, 4′-Pentyl-4-biphenylcarbonitrile exhibits a refractive index of about 1.7 for TE polarized light and about 1.5 for TM polarized light. Liquid crystal comprising 4′-Pentyl-4-biphenylcarbonitrile is also known as 5CB, manufactured by Sigma-Aldrich, LLC, St. Louis, Mo., USA., while 4-trans-pentylcyclohexylcyanobenzene liquid crystal is also known as 5PCH, manufactured by Maison Chemical Co. Ltd, China. The liquid crystals MLC-9200-00, MLC-9200-100, MLC-6241-000, MLC-6608, TL-216, E44 are manufactured by Merck, Darmstadt, Germany.

In some examples, an alignment layer (not illustrated) may be employed. For example, the alignment layer(s) may be employed to one or both of establish a predetermined alignment or orientation of molecules of the liquid crystal 130 and to adjust the orientation. An alignment layer may be employed to establish an orientation of the molecules in a particular homogeneous alignment without an applied electric field, for example. Further, the inclusion of one or more alignment layers may be used to counteract or mitigate local distortion of the liquid crystal molecules that may result from contact with the diffraction grating, in some examples.

In some examples, the grating-based light modulator 100 further includes an electrode 150. The electrode 150 is used to provide an electric field that produces one or both of the first state and the second state of the liquid crystal 130. For example, the electric field may produce the first state of the liquid crystal 130 while an absence of the electric field may allow the liquid crystal 130 to return to the second state. In other examples, the second state may be produced by application of the electric field while the first state is provided by an absence of the electric field. In yet other examples, a first electric field provided by the electrode 150 produces the first state and a second electric field provided by the electrode 150 produces the second state of the liquid crystal 130.

In some examples, a plurality of electrodes 150 may be employed to produce the electric field across the liquid crystal 130. In particular, as illustrated in FIGS. 1 and 2, the grating-based light modulator 100 includes a first electrode 150 and a second electrode 150′ positioned on opposite sides of the liquid crystal 130. Moreover, pairs of the first and second electrodes may be aligned with corresponding diffraction gratings 120 to affect the liquid crystal 130 in the vicinity of the corresponding diffraction gratings 120. In FIG. 1, the second electrode 150′ is illustrated on the lid 144 of the cavity 140 and the first electrode 150 is illustrated at a back surface of the plate light guide 110 corresponding to each diffraction grating 120, by way of example and not limitation. In another example (not illustrated), the first electrode 150 may also be located on backside or bottom of the cavity 140 (e.g., on the diffraction grating 130). In FIG. 2, the first electrode 150 is illustrated on a top surface of the bottom plate 116 adjacent to the liquid crystal 130 and the second electrode 150′ is illustrated on a top surface of the top plate 114, again by way of example and not limitation. Moreover, pairs of the first and second electrodes may be aligned with corresponding diffraction gratings 120. According to various examples, one or both of the first electrode 150 and the second electrodes 150′ may include a transparent conductor material such as, but not limited to, indium tin oxide (ITO), fluorine doped tin oxide (FTO), doped zinc oxide, or various conductive organic films.

Application of a first voltage to the electrodes 150, 150′ may be used to one or both of Change the state and set the first state of the liquid crystal 130 in contact with the diffraction grating 120. Further, application of a second voltage to the electrodes 150, 150′ may be used to one or both of change the state and set the second state of the liquid crystal 130. In some examples, one of the first and the second voltages may be approximately zero volts (0 V) while the other voltage is substantially different from zero volts to cause the change or set the state. In some examples, one or both of the first and second voltages represent an alternating current (AC) voltage. The pairs of first and second electrodes 150, 150′ may be selectively activated to turn ON or turn OFF the corresponding diffraction gratings 120 along the light guide 110, according to various examples.

In some examples, the grating-based light modulator 100 is substantially transparent. If particular, the plate light guide 110, the diffraction grating 120 and at least the liquid crystal 130 in the second state may be optically transparent in a direction orthogonal to a direction of light propagation in the plate light guide 110, according to some examples. Optical transparency allow objects on one side of the grating-based light modulator 100 to be seen from an opposite side, for example.

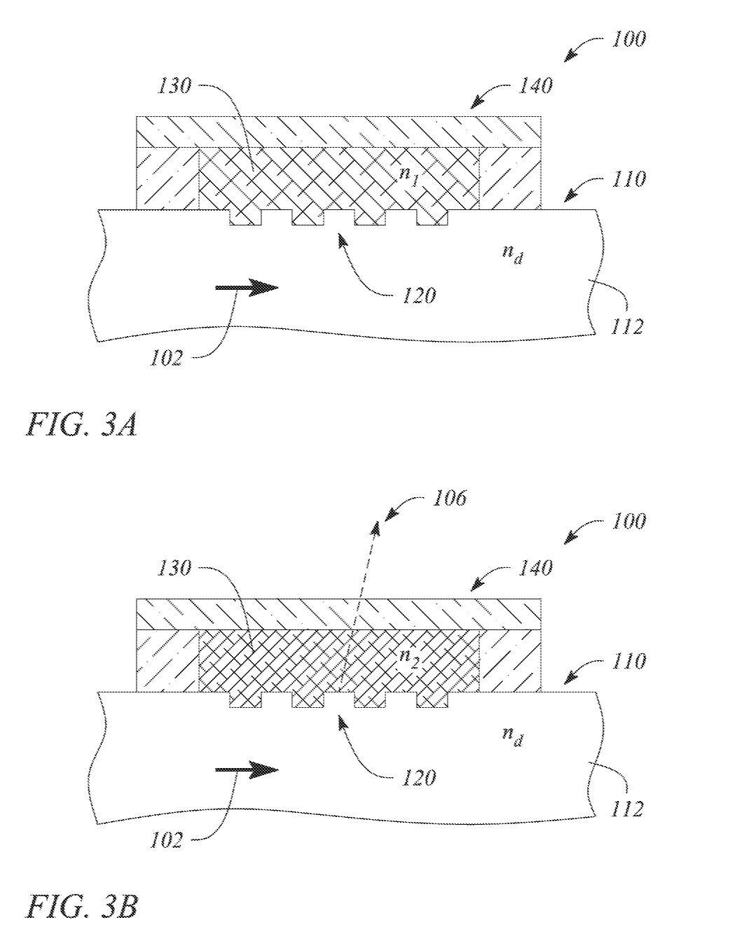

FIG. 3A illustrates a cross sectional view of a portion of a grating-based light modulator 100, according to an example consistent with the principles described herein. FIG. 3B illustrates a cross sectional view of the portion of the grating-based light modulator 100 of FIG. 3A, according to an example consistent with the principles described herein. In particular, FIG. 3A illustrates the grating-based light modulator 100 with the liquid crystal 130 in the first state having the first refractive index n₁ that matches the refractive index n_{d} of the diffraction grating 130 (i.e., n₁≈n_{d}). Note that, as illustrated in FIGS. 3A and 3B, the diffraction grating 120 and light guide 110 comprise the same material and thus have the same refractive index n_{d}. FIG. 3B illustrates the liquid crystal 130 is in the second state with the second refractive index n₂ mismatched with the diffraction grating refractive index n_{d} (i.e., n₂≠n_{d}). Further, FIGS. 3A and 3B illustrate the liquid crystal 130 confined substantially outside of the guide layer 112 (e.g., by cavity 140) analogous to the configuration of FIG. 1.

As illustrated in FIG. 3A, the match between the refractive indices of the liquid crystal 130 and the diffraction grating 120 defeats the diffractive coupling and the guided light 102 is not coupled out of the plate light guide 110. For example, the refractive index of the diffraction grating 120 may be about 1.5 and the first state of the liquid crystal 130 may be a homeotropic alignment of the liquid crystal 130 molecules having a refractive index of about 1.5 (i.e., for guided light 102). The match between the refractive indices at 1.5 causes the diffractive grating 120 to appear as a substantially smooth surface of the plate light guide 110 thus defeating the diffractive coupling of the light 102 guided in the plate light guide 110.

In FIG. 3B, the liquid crystal 130 has been switched to the second state with a homogeneous alignment of the liquid crystal 130 molecules and having a refractive index of about 1.7 (i.e., for the guided light 102). As illustrated in FIG. 3B, the mismatch between the refractive indices of the diffraction grating 120 and the liquid crystal 130 (e.g., 1.5 vs. 1.7) enables a portion the guided light 102 to be coupled out of the plate light guide 110 by diffractive coupling to result in emission of the modulated light 106 from the diffraction grating 120.

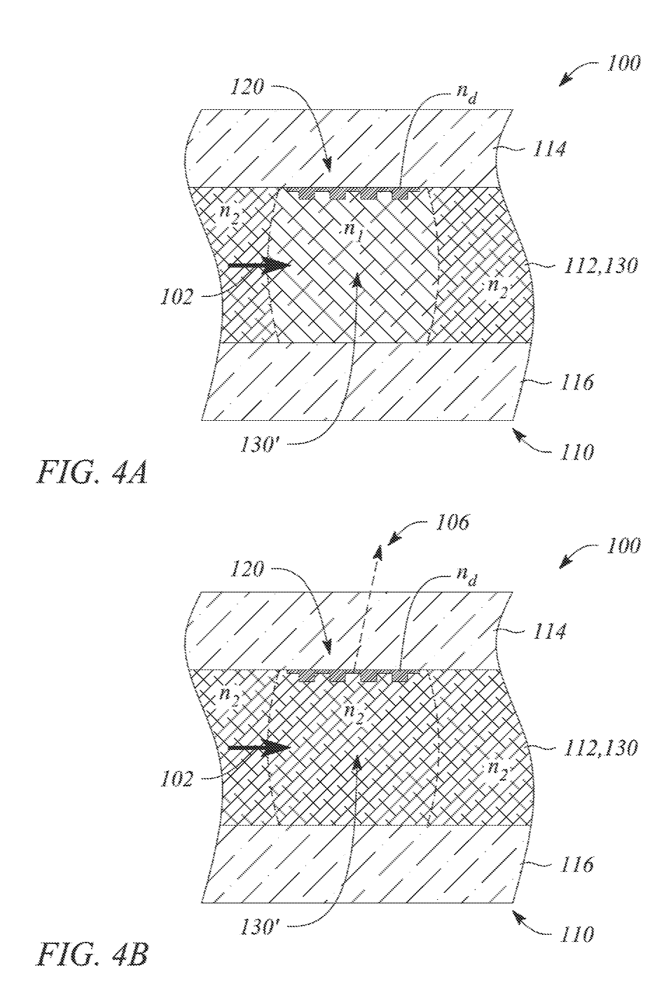

FIG. 4A illustrates a cross sectional view of a portion of another grating-based light modulator 100, according to an example consistent with the principles described herein. FIG. 4B illustrates a cross sectional view of the portion of the grating-based light modulator 100 of FIG. 4A, according to an example consistent with the principles described herein. In particular, FIG. 4A illustrates a configuration analogous to that illustrated in FIG. 2 in which the guide layer 112 is made up of the liquid crystal 130, which is sandwiched between the top and bottom plate 114, 116. The diffraction grating 120 comprises a film having a refractive index n_{d} applied to a bottom surface of the top plate 114, as illustrated. In FIG. 4A, a bulk of the liquid crystal 130 is in the second state having the second refractive index n₂, while a portion of the liquid crystal 130′ in contact with the diffraction grating 120 is in the first state having the first refractive index n₁. The first refractive index n₁ of the first state substantially matches the refractive index n_{d} of the diffraction grating 120 (i.e., n₁≈n_{d}). In FIG. 4B, substantially all of the liquid crystal 130 is in the second state having the second refractive index n₂. The second refractive index n₂ of the second state is mismatched with the diffraction grating refractive index n_{d} (i.e., n₂≠n_{d}).

As illustrated in FIG. 4A, the refractive index match at the portion of the liquid crystal 130′ in contact with the diffraction grating 120 defeats the diffractive coupling and no portion of the guided light 102 is coupled out of the plate light guide 110. For example, the refractive index of the diffraction grating 120 may be about 1.5 and the first state (e.g., a homeotropic alignment of the liquid crystal molecules) may also have a refractive index of about 1.5 for the guided light 102. To the guided light 102, the matched refractive indices of 1.5 causes the diffraction grating 120 to appear as a substantially smooth surface to defeat the diffractive coupling so modulated light is not emitted. The bulk of the liquid crystal 130 away from the diffraction grating 120 in the second state may have a refractive index of about 1.7, for example. The refractive index of 1.7 of the bulk of the liquid crystal 130 may facilitate guiding the guided light 103 by total internal reflection at interfaces with the top and bottom plates 114, 116 that both have refractive indices of less than 1.7, for example. The difference in refractive indices between the liquid crystal 130′ and the bulk of the liquid crystal 130 is achieved using a stimulus, or a lack thereof, for example a variable electric field directed in the vicinity of the diffraction grating 120. The variable electric field may be provided by an electrode or pair or electrodes 150, 150′ (not illustrated FIGS. 4A and 4B).

In FIG. 4B, the liquid crystal 130′ in contact with the diffraction grating 120 has been switched to the second state with a refractive index of about 1.7 for the guided light 102. The mismatch between the refractive indices of the diffraction grating 120 and liquid crystal 130′ in contact with the diffraction grating 120 enables a portion the guided light 102 to be coupled out of the plate light guide 110 by diffractive coupling and emitted as the modulated light 106 from the diffraction grating 120, as illustrated in FIG. 4B.

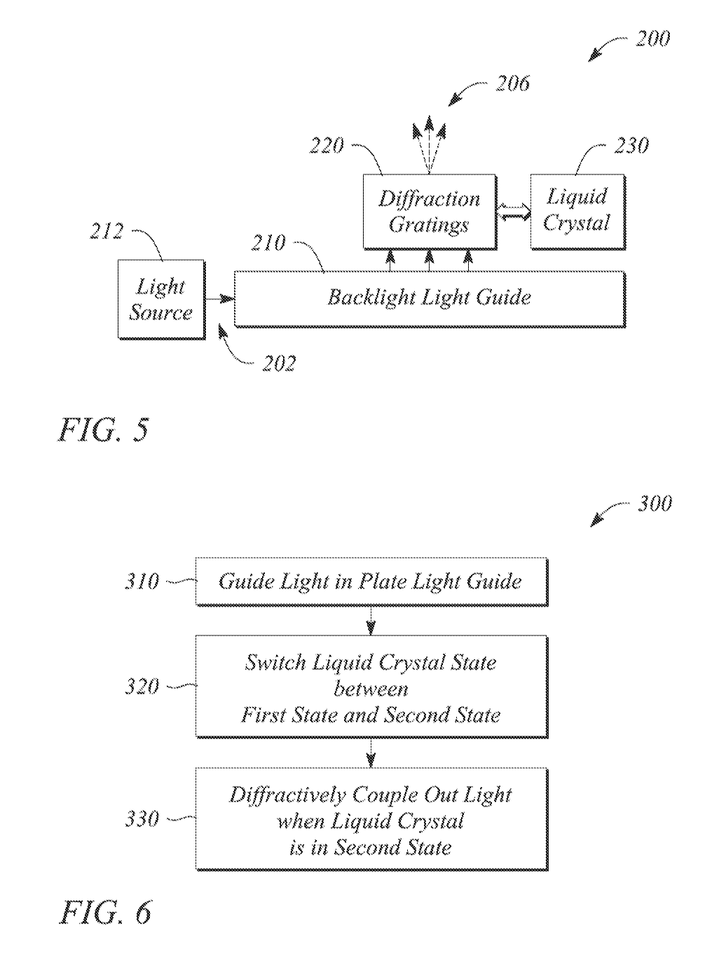

According to some examples of the principles described herein, an electronic display is provided. FIG. 5 illustrates a block diagram of an electronic display 200, according to an example consistent with the principles described herein. The electronic display 200 employs liquid crystal based grating modulation to modulate pixels of the display 200. Further, emitted modulated light 206 may be preferentially directed toward a viewing direction of the electronic display 200.

The electronic display 200 illustrated in FIG. 5 includes is backlight light guide 210. The backlight light guide 210 is configured to guide light 202 from a light source 212. The light 202 is guided by total internal reflection between a front surface and a back surface of the backlight light guide 210, according to various examples. The light source 212 may be substantially similar to the light source 104 described above with respect to the grating-based light modulator 100, for example. Further, in some examples, the backlight light guide 210 may be substantially similar to the plate light guide 110 described above with respect to the grating-based light modulator 100. For example, the backlight light guide 210 may be a slab optical waveguide. In another example, the backlight light guide 210 may include a guide layer sandwiched between a top or front plate and a bottom or back plate.

As illustrated in FIG. 5, the electronic display 200 further includes a plurality of diffraction gratings 220 at the front surface of the backlight light guide 210. The plurality of diffraction gratings 220 is configured to couple out portions of the guided light 202 through the front surface of the backlight light guide 210 by diffractive coupling. In particular, each diffraction grating 220 of the plurality may couple out a different portion of the guided light 202. According to some examples, the diffraction gratings 220 of the plurality are substantially similar to the diffraction grating 120 described above with respect to the grating-based light modulator 100. For example, the diffraction grating 220 may include or be made up of a plurality of features (e.g., grooves, ridges, bumps, holes, or combinations thereof) in the front surface of the backlight light guide 210. In some examples, different ones of the diffraction gratings 220 of the plurality are selectively configured to couple out portions of the guided light 202, and in different directions to produce a three dimensional (3-D) electronic display 200.

The electronic display 200 further includes a liquid crystal 230 in contact with the diffraction gratings 220. The liquid crystal 230 has a selectable first state with a first refractive index to defeat the diffractive coupling. The liquid crystal 230 has a selectable second state with a second refractive index to facilitate the diffractive coupling. In particular, the first refractive index is configured to substantially match a refractive index of the diffraction grating 220, while the second refractive index is substantially mismatched with the diffraction grating refractive index. A selection of the selectable first and second states and corresponding diffraction gratings 220 is configured to modulate the portion of coupled out light as a modulated pixel of the electronic display 200.

In some examples, the liquid crystal 230 is substantially similar to the liquid crystal 130 described above with respect to the grating-based light modulator 100. In particular, the first state may include an orientation of molecules of the liquid crystal 230 configured to provide the first refractive index. Similarly, the second state may include another orientation of the liquid crystal molecules configured to provide the second refractive index. The first refractive index may be configured to substantially match a refractive index of a material of a diffraction grating 220 of the plurality for a predetermined polarization of the guided light. The second refractive index of the liquid crystal may be configured to differ from the diffraction grating refractive index for the predetermined polarization of the guided light. The selective or controlled states of the liquid crystal molecules and the corresponding diffraction gratings provide modulation of light (e.g., pixels being turned ON and OFF) emitted by the electronic display 200.

In some examples, the backlight light guide 210 includes a slab of optically transmissive material and the liquid crystal 230 is substantially confined to a portion of the front surface of the backlight light guide 210. In particular, the liquid crystal 230 is confined to a portion of the front surface at a diffraction grating 220 of the plurality of diffraction gratings 220. Further, the liquid crystal 230 may be confined substantially outside of the optically transmissive material of the slab. However, the liquid crystal 230 may extend into the surface of the slab to fill features of the diffraction grating 220, according to some examples (e.g., as illustrated in FIG. 1). The liquid crystal 230 may be confined at the front surface portion of the backlight light guide 210 by a cavity. The cavity may be substantially similar to the cavity 140 described above with respect to the grating-based light modulator 100, for example.

In other examples, the backlight light guide 210 includes the liquid crystal 230 sandwiched between a top plate and a bottom plate. The diffraction grating 220 may be located at an interface between the top plate and the liquid crystal 230. For example, the diffraction grating 220 may be on or in a bottom surface of the top plate (e.g., as illustrated in FIG. 2). Electrodes (not illustrated) may be provided to selectively control diffractive coupling from individual diffraction gratings 220 of the plurality to modulate individual pixels, for example.

According to some examples of the principles described herein, a method of grating-based light modulation is provided. In particular, the method of grating-based light modulation employs a liquid crystal to modulate light by alternately defeating and facilitating diffractive coupling. The liquid crystal defeats diffractive coupling by exhibiting a refractive index that substantially matches a refractive of a diffraction grating. The liquid crystal facilitates diffractive coupling by exhibiting another refractive index that is mismatched to the diffraction grating index of refraction. The method of grating-based light modulation may employ the grating-based light modulator 100, described above, according to some examples.

FIG. 6 illustrates a flow chart of a method 300 of grating-based light modulation, according to an example consistent with the principles described herein. The method 300 of grating-based light modulation includes guiding 310 light in a plate light guide using total internal reflection (TIR). In some examples, the plate light guide may be substantially similar to the plate light guide 110 described above with respect to the grating-based light modulator 100.

In some examples the plate light guide includes a solid sheet or slab of optically transparent, substantially solid material to guide 310 the light by total internal reflection with in the sheet. Guiding 310 light in the plate light guide may include propagating light in the slab between a top surface and a bottom surface of the sheet. In other examples, the plate light guide includes a liquid (or liquid-like material) sandwiched between a top plate and a bottom plate, the liquid being configured to guide 310 the light by total internal reflection within the liquid. In some examples, the liquid includes or is a liquid crystal. In these examples, guiding 310 light in the plate light guide includes propagating light within the liquid crystal sandwiched between a top plate and a bottom plate.

The method 300 of grating-based light modulation further includes switching 320 a state of a liquid crystal between a first state and a second state. The liquid crystal is in contact with a diffraction grating at a surface of the plate light guide. According to some examples, a refractive index of the liquid crystal in the first state substantially matches a refractive index of the diffraction grating to defeat the diffractive coupling, while the liquid crystal refractive index in the second state is mismatched with the diffraction grating refractive index.

The liquid crystal may be substantially similar to the liquid crystal 130 described above with respect to the grating-based light modulator 100, for example. Moreover, the diffraction grating may be substantially similar to the diffraction grating 120 described above with respect to the grating-based light modulator 100, according to some examples. In particular, when guiding 310 light includes propagating light in a solid sheet, the diffraction plating may be located at the top surface of the sheet and the liquid crystal may be confined to a portion of the top surface that includes the diffraction grating. Alternatively, when guiding 310 light includes propagating light in the liquid crystal sandwiched between parallel top and bottom plates, the diffraction grating may be located at a bottom surface of the top plate.

In some examples, switching 320 the state of the liquid crystal may include one or both of applying an electric field to the liquid crystal and changing the electric field applied to the liquid crystal. The electric field may be applied by using an electrode such as, but not limited to, the electrode 150 or the electrode pair 150, 150′ described above with respect to the grating-based light modulator 100, for example.

The method 300 of grating-based light modulation further includes coupling 330 out a portion of the TIR guided light by diffractive coupling. In particular, the portion of the TIR guided light is coupled out through the diffraction grating when the liquid crystal in the vicinity of (e.g., in contact with) the diffraction grating is switched 320 to the second state. However, substantially no TIR guided light is coupled out when the liquid crystal is switched 320 to the first state and diffractive coupling is defeated, according to various examples.

Thus, there have been described examples of a grating-based light modulator, a electronic display and a method of grating-based light modulation that employs a liquid crystal to alternately facilitate and defeat diffractive coupling of light from a plate light guide. It should be understood that the above-described examples are merely illustrative of some of the many specific examples that represent the principles described herein. Clearly, those skilled in the art can readily devise numerous other arrangements without departing from the scope as defined by the following claims.

What is claimed is:

1. A grating-based light modulator comprising:
a plate light guide comprising a guide layer to guide light by total internal reflection (TIR);
a diffraction grating at a surface of the guide layer to couple out a portion of the TIR guided light through the surface using diffractive coupling; and
a liquid crystal in contact with the diffraction grating the liquid crystal having a first state with a first refractive index that substantially matches a refractive index of a material of the diffraction grating to defeat the diffractive coupling and having a second state with a second refractive index that differs from the first refractive index to facilitate the diffractive coupling.

2. The grating-based light modulator of claim 1, wherein the guide layer of the plate light guide comprises a sheet of optically transmissive material that is substantially solid, the optically transmissive material having a refractive index that is higher than a refractive index outside of surfaces of the sheet.

3. The grating-based light modulator of claim 1, wherein the liquid crystal is substantially confined to a portion of the guide layer surface that includes the diffraction grating, the confined liquid crystal being substantially outside of the guide layer of the plate light guide.

4. The grating-based light modulator of claim 3, further comprising a cavity to confine the liquid crystal outside of the guide layer, the cavity comprising a pair of walls adjacent to and extending away from the guide layer surface and a lid to bridge between the walls, wherein the pair of walls are on either side of the diffraction grating.

5. The grating-based light modulator of claim 1, wherein the plate light guide further comprises a top plate and a bottom plate, the guide layer comprising the liquid crystal sandwiched between the top and bottom plate, and wherein the diffraction grating is at a bottom surface of the top plate adjacent to an interface between the top plate and the liquid crystal.

6. The grating-based light modulator of claim 1, wherein the liquid crystal comprises a nematic liquid crystal in which the first state is characterized by a homeotropic alignment of molecules of the nematic liquid crystal and the second state is characterized by a homogeneous alignment of the nematic liquid crystal molecules, the homeotropic alignment providing the first refractive index and the homogeneous alignment providing the second refractive index.

7. The grating-based light modulator of claim 1, further comprising a first electrode and a second electrode to apply an electric field to the liquid crystal at the diffraction grating, wherein application of a first voltage across the that and second electrodes is to produce the liquid crystal first state and application of a second voltage across the first and second electrodes is to produce the liquid crystal second state.

8. An electronic display comprising the grating-based light modulator of claim 1, wherein modulated light coupled out by the diffraction grating under control of the liquid crystal is modulated light of a pixel of the electronic display.

9. An electronic display comprising:
a backlight light guide to guide light from a light source by total internal reflection between a front surface and a back surface of the backlight light guide;
a plurality of diffraction gratings at the front surface, a diffraction grating of the plurality to couple out a portion of the guided light through the front surface by diffractive coupling; and
a liquid crystal in contact with the diffraction gratings and having a selectable first state with a first refractive index to defeat diffractive coupling and a selectable second state with a second refractive index to facilitate diffractive coupling,
wherein selection of the first and second states is to modulate the coupled out light portion as a modulated pixel of the electronic display.

10. The electronic display of claim 9, wherein the selectable first state comprises an orientation of molecules of the liquid crystal to provide the first refractive index, the selectable second state comprising another orientation of the liquid crystal molecules to provide the second refractive index, the first refractive index being substantially matched to a refractive index of a material of the diffraction grating of the plurality for a predetermined polarization of the guided light the second refractive index of the liquid crystal being different from the diffraction grating material refractive index for the predetermined polarization of the guided light.

11. The electronic display of claim 9, wherein the backlight light guide comprises a slab of optically transmissive material, the liquid crystal being confined to a portion of the front surface of the backlight light guide at the diffraction grating of the plurality, the confined liquid crystal being substantially outside of the optically transmissive material of the slab.

12. The electronic display of claim 9, wherein the backlight light guide comprises the liquid crystal sandwiched between a top plate and a bottom plate, the diffraction gratings being at an interface between the top plate and the liquid crystal.

13. The electronic display of claim 9, wherein different ones of the diffraction gratings of the plurality to couple out portions of the guided light in different directions to produce a three dimensional (3-D) electronic display.

14. A method of grating-based light modulation, the method comprising:
guiding light in a plate light guide using total internal reflection (TIR);
switching a state of a liquid crystal between a first state and a second state, the liquid crystal being in contact with a diffraction grating at a surface of the plate light guide; and
coupling out a portion of the TIR guided light by diffractive coupling using the diffraction grating when the liquid crystal is switched to the second state,
wherein a refractive index of the liquid crystal in the first state substantially matches a refractive index of the diffraction grating to defeat the diffractive coupling, the liquid crystal refractive index in the second state being mismatched with the diffraction grating refractive index.

15. The method of light modulation of claim 14, wherein guiding light in a plate light guide using TIR comprises either:
propagating light in a sheet of optically transparent, substantially solid material between a top surface and a bottom surface of the sheet, the diffraction grating being at the top surface of the sheet, the liquid crystal being confined to a portion of the top surface that includes the diffraction grating; or
propagating light within the liquid crystal sandwiched between a top plate and a bottom plate, the diffraction grating being at a bottom surface of the top plate.
